(19) United States
(12) Patent Application Publication
(10) Pub. No.: US 2025/0273877 A1
(43) Pub. Date: Aug. 28, 2025

(54) QUANTIFICATION OF POLARIZATION PURITY OF DUAL-POLARIZED ANTENNA

(71) Applicants: University Corporation for Atmospheric Research, Boulder, CO (US); Michigan Technological University, Houghton, MI (US)

(72) Inventors: Jothiram Vivekanandan, Boulder, CO (US); Alexander B. Kostinski, Houghton, MI (US); Daniel Kestner, Hancock, MI (US)

(21) Appl. No.: 19/064,622

(22) Filed: Feb. 26, 2025

Related U.S. Application Data
(60) Provisional application No. 63/557,957, filed on Feb. 26, 2024.

(51) Int. Cl. H01Q 25/00; H01Q 3/34; H04B 7/0426

(52) U.S. Cl. CPC H01Q 25/001; H01Q 3/34; H04B 7/043

(57) ABSTRACT

A method may receive, from a dual-polarized antenna, first polarization data from a first channel and second polarization data from a second channel having a polarization orientation that is different from the first channel, the first and second polarization data representing signal from a noise source including randomly polarized noise. A method may generate filtered first polarization data by filtering data from the first polarization data that is more than a predetermined distance from a first polarization data mean. A method may generate filtered second polarization data by filtering data from the second polarization data that is more than the predetermined distance from a second polarization data mean. A method may determine a tilt polarity mismatch and an ellipticity polarity mismatch based on the filtered first polarization data and the filtered second polarization data.

### CROSS-REFERENCE TO RELATED APPLICATION

This application claims priority to U.S. Provisional Patent Application No. 63/557,957, filed on Feb. 26, 2024, the disclosure of which is incorporated by reference herein in its entirety.

### STATEMENT REGARDING FEDERALLY SPONSORED RESEARCH OR DEVELOPMENT

The subject matter disclosed in this application was made with Government support under award AGS-1852977, awarded by the National Science Foundation and under award NA18OAR4590431, awarded by the National Oceanic Atmospheric Administration. The Government has certain rights in the subject matter disclosed in this application.

### BACKGROUND

A dual-polarized antenna can receive signals on two orthogonal polarization planes (e.g., horizontal/vertical or circular). Examples of dual-polarized antennas include phased array antennas, crossed dipole antennas, horn antennas with dual-polarization, dual-polarized parabolic dish antennas, log-periodic dual-polarized antennas, and so forth.

A phased array antenna is an advanced antenna system composed of multiple radiating elements, each capable of independently controlling the phase of its signal. By precisely adjusting the phase across the array, these antennas can electronically steer their beam in different directions without requiring mechanical movement. This makes them highly efficient and adaptable for applications that require rapid beam shifting, such as radar, satellite communications, and 5G networks. Phased array antennas can generate multiple beams simultaneously, enabling them to track multiple targets or maintain robust communication links in complex environments. Their ability to dynamically control beams in real time makes them superior to traditional fixed or mechanically steered antennas.

Phased arrays are crucial in aviation, telecommunications, and scientific research. In military and aerospace applications, they are used in radar systems for target tracking, missile guidance, and surveillance, providing high-speed scanning and real-time adaptability. In a weather radar system, phased arrays enable fast, high-resolution atmospheric scanning to monitor severe storms and precipitation patterns. Satellite communication systems benefit from phased arrays by maintaining seamless connectivity with moving satellites, eliminating the need for bulky mechanical tracking systems. They are also vital in 5G and wireless networks, where beamforming helps enhance signal strength, improve network capacity, and reduce interference. Their importance lies in their ability to provide fast, precise, and highly reliable communication and sensing capabilities, making them important for many scientific, and commercial technologies.

### BRIEF DESCRIPTION OF THE DRAWINGS

FIG. 1 depicts a block diagram of a method, in accordance with an example.

FIG. 2 depicts first polarization data and the second polarization data, according to examples.

FIG. 3 depicts filtered first polarization data and filtered second polarization data, according to examples.

FIG. 4 depicts a first plot of cross-correlation coefficients vs tilt polarization mismatch and a second plot of cross-correlation coefficients vs ellipticity polarization mismatch, according to examples.

FIG. 5 depicts S-Pol radar data, according to examples.

FIG. 6 depicts a computing device, according to examples.

### SUMMARY

In some aspects, the techniques described herein relate to a method including: receiving, from a dual-polarized antenna, first polarization data from a first channel and second polarization data from a second channel having a polarization orientation that is different from the first channel, the first polarization data and the second polarization data representing signal from a noise source including randomly polarized noise; generating filtered first polarization data by filtering data from the first polarization data that is more than a predetermined distance from a first polarization data mean; generating filtered second polarization data by filtering data from the second polarization data that is more than the predetermined distance from a second polarization data mean; determining a tilt polarity mismatch and an ellipticity polarity mismatch based on the filtered first polarization data and the filtered second polarization data; wherein at least one of the tilt polarity mismatch or the ellipticity polarity mismatch are used to determine a polarity error of the dual-polarized antenna.

In some aspects, the techniques described herein relate to a system including: a processor; and a memory configured with code operable to: receive, from a dual-polarized antenna, first polarization data from a first channel and second polarization data from a second channel having a polarization orientation that is different from the first channel, the first polarization data and the second polarization data representing signal from a noise source including randomly polarized noise; generate filtered first polarization data by filtering data from the first polarization data that is more than a predetermined distance from a first polarization data mean; generate filtered second polarization data by filtering data from the second polarization data that is more than the predetermined distance from a second polarization data mean; determine a tilt polarity mismatch and an ellipticity polarity mismatch based on the filtered first polarization data and the filtered second polarization data; wherein at least one of the tilt polarity mismatch or the ellipticity polarity mismatch are used to determine a polarity error of the dual-polarized antenna.

In some aspects, the techniques described herein relate to a non-transitory computer-readable medium storing instructions that, when executed by a processor, cause a processor to: receive, from a dual-polarized antenna, first polarization data from a first channel and second polarization data from a second channel having a polarization orientation that is different from the first channel, the first polarization data and the second polarization data representing signal from a noise source including randomly polarized noise; generate filtered first polarization data by filtering data from the first polarization data that is more than a predetermined distance from a first polarization data mean; generate filtered second polarization data by filtering data from the second polarization data that is more than the predetermined distance from a second polarization data mean; determine a tilt polarity mismatch and an ellipticity polarity mismatch based on the filtered first polarization data and the filtered second polarization data; wherein at least one of the tilt polarity mismatch or the ellipticity polarity mismatch are used to determine a polarity error of the dual-polarized antenna.

### DESCRIPTION

The present disclosure describes methods to estimate the polarization purity of a dual-polarized antenna directly based on an observation of randomly polarized noise. A measured cross-correlation coefficient ρ_{HV} is calculated from the randomly polarized noise data received at the dual-polarized antenna and used to estimate tilt and ellipticity polarity mismatches of the polarization channels, which represent the polarization purity of the antenna.

An observation of the randomly polarized noise received from the dual-polarized antenna includes data representing signals received from each the of two polarization channels in the antenna. First polarization channel data may be received from a first channel having a first polarization orientation, and second polarization channel data may be received from a second channel having a second polarization orientation. For example, the polarization orientations can be horizontal/vertical or right/left circular, etc. Each of the first polarization data and the second polarization data can be represented by two sets of time series data representing an in-phase component I and a quadrature component Q. Thus, the first polarization channel data and the second polarization data received at the dual-polarized antenna can be represented collectively by four time series data sets. In examples, outlier data is identified and removed from each of the four time series data sets before a measured cross-correlation coefficient μm is determined. For example, ranges of time steps within the time series data that do not include statistically stationary data (i.e., the mean, variance, and autocovariance of that data do not remain constant) may be removed from all four time series data sets. In examples, clutter may also be identified and removed from the time series data. In examples, further mitigation actions may be taken upon determining tilt and ellipticity polarization mismatches to increase the polarization purity of the antenna.

While the example of a phased array antenna is discussed in depth in the disclosure, this is not intended to be limiting. It should be understood that the methods described in the present application may be applied to any dual-polarized antenna.

The phased array antenna configuration is a leading contender for next-generation weather radars, 5G, and 6G. In examples, the polarization of a phased array antenna and beam steering may be commanded electronically. 5G antennas typically use dual polarization, such as ±45° or vertical/horizontal polarization. Dual polarization may allow the same frequency to be used for two independent data streams, effectively doubling capacity. In some examples, 5G antennas also employ circular polarization (left-hand and right-hand circular polarization) to reduce signal degradation caused by multipath effects or physical obstructions.

Looking ahead to the near future, 6G antennas may utilize multi-polarization techniques that combine vertical, horizontal, and circular polarizations to maximize spectral efficiency. 6G antennas may feature reconfigurable polarization, enabling them to dynamically switch between different polarization states based on network demands and environmental conditions. This adaptability may support advanced applications such as holographic communication, extended reality, and seamless integration with satellite networks.

While 5G primarily operates in the sub-6 GHz and millimeter-wave (mmWave) frequency bands, it is anticipated that 6G may extend into terahertz frequencies, which may require more advanced polarization techniques. While 5G polarization uses dual and adaptive strategies to enhance capacity and reliability, 6G polarization may utilize multi-polarization, reconfigurability, and intelligent control to meet the needs of next-generation wireless systems.

5G may use multiple-input multiple-output (MIMO), with arrays of phased array antennas, for example, 4×4, 8×8, and up to massive MIMO with up to 256 antenna elements. MIMO may rely on precisely controlling polarization states between transmitting and receiving antenna elements. The phase and amplitude of antenna elements may steer the phased array antenna beam electronically in a specific direction and enable dynamic beamforming and beam steering. MIMO may be a cornerstone of both 5G and 6G communications, but its implementation in 6G may be significantly more advanced. While 5G MIMO focuses on massive MIMO and hybrid beamforming to enhance capacity and coverage, 6G MIMO may leverage ultra-massive MIMO, AI-driven optimization, and novel techniques like holographic MIMO and orbital angular momentum to support terahertz communication and next-generation applications.

Phased array antennas and other dual-polarized antennas rely on dual-polarization technology by detecting two orthogonally polarized signals, which can be either vertical and horizontal or left circular and right circular. Maintaining high polarization purity and isolation between these signals is critical to ensuring accurate beam steering without signal leakage or unwanted interference. However, it is a technical problem to achieve and maintain polarization purity during both fabrication and long-term operation, as both fabrication and long-term operation present significant challenges.

One of the biggest challenges to the above-mentioned applications of dual-polarized antennas is polarization leakage. Polarization leakage occurs when a dual-polarized antenna unintentionally emits energy in an undesired polarization state. This leakage reduces signal clarity, increases interference, and weakens beamforming accuracy, particularly in applications that rely on strict polarization control, such as dual-polarized radar, satellite links, and MIMO (multiple-input multiple-output) systems. Poor polarization purity, a result of polarization leakage, can lead to cross-polarization interference, where signals mix between different polarization channels, degrading overall system performance. Addressing polarization leakage is crucial for ensuring accurate signal processing, reducing communication errors, and enhancing the effectiveness of phased array antennas in high-performance applications.

During the fabrication of a phased array antenna, the polarization purity of each phased array antenna element may be characterized and validated to ensure proper performance. Over time, polarization may drift in a phased array antenna because elements like waveguides and phase shifters are sensitive to temperature changes. In addition, transducer phase shifts may develop defects, affecting signal integrity.

The polarization error in an antenna refers to the extent to which the polarization channels deviate from perfect orthogonality. This occurs when a channel designed to receive signals with a first polarization also picks up unwanted signal components from a second, orthogonal polarization, leading to cross-polarization leakage. Polarization errors may include polarization mismatch, cross-polar discrimination, and polarization impurity in antenna elements. Errors may cause signal leakage between differently polarized MIMO streams, resulting in interference. Signal leakage may reduce channel capacity. The polarization leakage ratio quantifies the leakage.

A lower polarization leakage ratio may indicate higher polarization purity and isolation. High polarization purity may be critical for dual-polarized systems like 2×2 or 4×4 MIMO to isolate horizontal and vertical spatially multiplexed streams. Calibration (or characterization, quantification, estimation) may help characterize and compensate for hardware imperfections causing deviations from ideal polarization performance. Maintaining pristine polarization orthogonality may present an ongoing challenge, especially in wideband and millimeter-wave bands planned for 5G/6G MIMO. Polarization errors may degrade MIMO system capacity and reliability, and mitigating their effects through careful antenna design, calibration, and compensation techniques is highly desirable.

Prior methods of determining polarization purity included using ellipsometry and sphere calibration. Both techniques require taking an instrument offline for long amounts of time to perform testing in a calibration lab. The testing itself is expensive and difficult due to the extreme sensitivity of ellipsometry and sphere calibration to measurement conditions and the need for precise data acquisition and analysis. As a result, it is presently difficult for the operators of dual-polarized antenna instruments to monitor polarization purity without taking instruments offline for days and incurring significant expense.

The technical solution provided in the present disclosure is to directly estimate the polarization purity of a dual-polarized antenna based on observations of randomly polarized noise. First, a cross-correlation coefficient ρ_{HV} is measured based on the randomly polarized noise signal measured by the dual polarization channel antenna. The measured cross-correlation coefficient ρ_{HV} is then used to determine the tilt polarization mismatch and the ellipticity polarization mismatch between the polarization channels, providing a measure of the antenna's polarization purity.

The methods described herein may be performed relatively quickly (in as little as 5 minutes) in situ, without the need to remove antenna elements from an instrument and send them to a lab. Because the methods allow for the verification of polarization purity with little downtime time or expense, operators can monitor their antennae more frequently and mitigate polarization errors more quickly when they arise. Due to the plug-and-play nature of some phased array antenna elements, actions to mitigate polarization errors can be easily targeted using the present methods and executed quickly, for example by replacing antenna elements identified as problematic. The methods described herein may therefore result in more consistent data that is acquired with virtually no downtime and less expense.

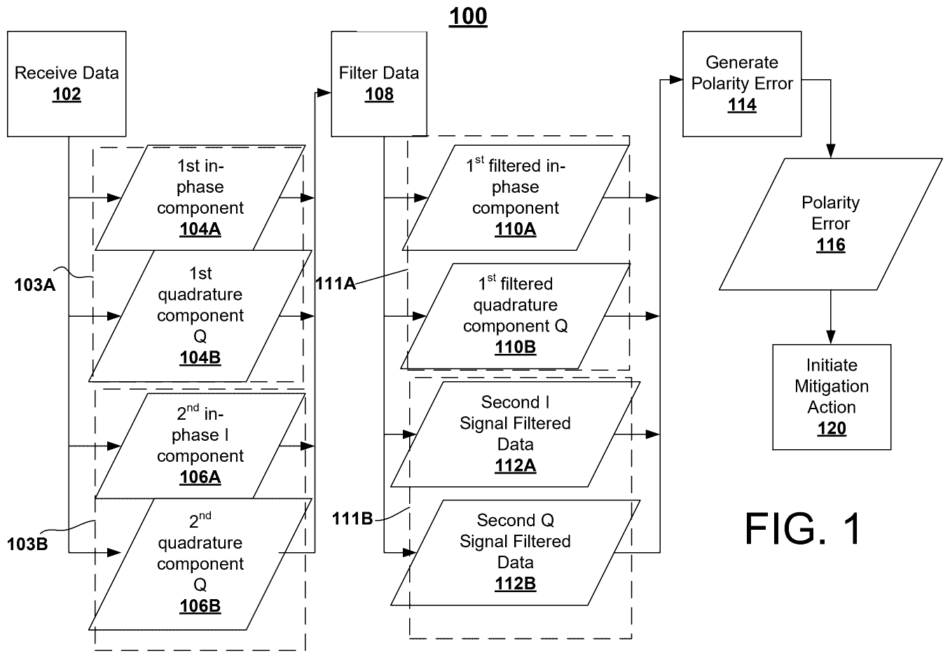

FIG. 1 depicts a block diagram of a method 100, in accordance with an example. Method 100 may be executed to determine the polarization purity of a dual-polarized antenna. Put another way, the method 100 may be used to detect polarization non-orthogonality (polarization error) in a pair of cross-polarized receivers. In examples, method 100 may be performed in real-time or in post-processing. For example, method 100 may include any combination of steps 102, 108, and 114. Method 100 may begin with step 102.

In step 102, first polarization channel data 103A and the second polarization channel data 103B may be received for each respective receiver channel of the dual polarized antenna. In examples, the first polarization channel data 103A and second polarization channel data 103B may include time series data representing a complex scalar voltage V(t). The complex scaler voltage may be represented as:

$$V ( t ) = I ( t ) + j Q ( t ) \qquad ( Equation 1 )$$

wherein I(t) and jQ(t) represent the in-phase component I and the quadrature component Q data, respectively. The first polarization channel data 103A may further be represented as first in-phase component I 104A and first quadrature component Q 104B and the second polarization channel data 103B may be represented as second in-phase component I 106A and second quadrature component Q 106B. The first in-phase component I 104A, the first quadrature component Q 104B, the second in-phase component I 106A and second quadrature component Q 106B are time series data.

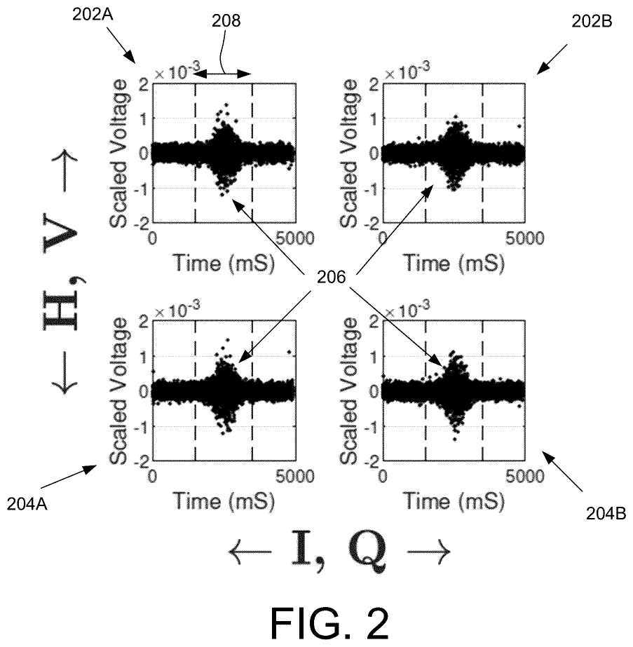

The orientation of the first polarization is different from the orientation of the second polarization. In examples, the first polarization orientation may be substantially orthogonal to the second polarization direction. In examples, the first polarization orientation may be orthogonal to the second polarization orientation as possible, or as close to orthogonal as possible. By substantially orthogonal, the first and second dual-polarized antenna may be within 5%, 2%, 1%, and 0.5% of one another. In examples, the first polarization orientation may be horizontal while the second polarization may be vertical, or the first polarization orientation may be right circular while the second polarization orientation is left circular. Thus, the time series data can be represented by four voltages, as illustrated in FIG. 2.

The first polarization channel data 103A and second polarization channel data 103B may represent randomly polarized noise. In examples, the randomly polarized noise may include solar microwave radiation, thermal noise, white Gaussian noise, etc. In examples, any type of polarimetric noise may be observed during this calibration generated with a circular Gaussian process with a density on the Poincare sphere is uniform.

In an example, the National Center for Atmospheric Research dual-polarized S-band radar may be used to obtain the first polarization channel data 103A and second polarization channel data 103B. For example, an azimuth scan may be performed across the solar disk at a fixed elevation angle of 20.7 degrees, spanning about 70 degrees in azimuth.

In the example of first polarization channel data 103A and second polarization channel data 103B, the time step size in the time series data is 1 ms and the length of the observation is 5 minutes. This provides time series data that is 5000 time steps long.

In examples, the first polarization data 103A and the second polarization channel data 103B may represent data obtained during a nominal scientific observation. In other words, the disclosed method to determine polarization error may be performed in situ, in the environment in which the array normally operates but during a small break from normal operation. This contrasts with conventional methods which require the array to be taken out of its normal operating environment and tested in a lab.

FIG. 2 depicts first polarization channel data 103A and second polarization channel data 103B, according to examples. In the figure, each x-axis represents time and each y-axis represents scaled voltage. Plot 202A depicts first in-phase component I 104A from the first polarization data, e.g., for a first polarization (e.g., vertical polarization, denoted as V although the first polarization could be right circular), plot 202B depicts first quadrature component Q 104B for the first polarization data, plot 204A depicts second in-phase component I 106A for the second polarization data, e.g., for a second polarization (e.g., horizontal polarization, denoted as H, although the second polarization could be left circular), and plot 204B depicts second quadrature component Q 106B for the second polarization data, according to examples.

In examples, method 100 may continue with step 108. In step 108, first polarization data 111A may be generated from first polarization channel data 103A, and second polarization data 111B may be generated from second polarization channel data 103B. In step 108, first filtered in-phase component I 110A may be generated from first in-phase component I 104A, first filtered quadrature component Q 110B may be generated from first quadrature component Q 104B, second filtered in-phase component I 112A may be generated from second in-phase component I 106A, and second filtered quadrature component Q 112B may be generated from second quadrature component Q 106B.

In step 108, features that do not represent randomly polarized noise may be removed from the example time series data. For example, while solar microwave emission is an ideal example of a circular Gaussian probability density function (a noise source that represents randomly polarized noise), it is not statistically stationary in variance due to the bulge 206 that may be seen in each of plots 202A-204B. The bulge 206 was due to an intermittent or transient artifact in the S-pol receiver.

In examples, a time range of first polarization channel data 103A and second polarization channel data 103B that includes non-stationary data may be filtered from the data. Filtering the data may mean removing it or amending it to a more reasonable value, such as a mean value. For example, returning to FIG. 2 a time range 208 that includes non-stationary data (bulge 206) is noted with vertical dashed lines in plot 202A. In examples, the data within the time range 208 may be truncated, or removed from the first polarization channel data 103A and the second polarization channel data 103B arrays, causing that filtered first polarization data 111A and the filtered second polarization data 111B to less data than the first polarization channel data 103A and the second polarization channel data 103B.

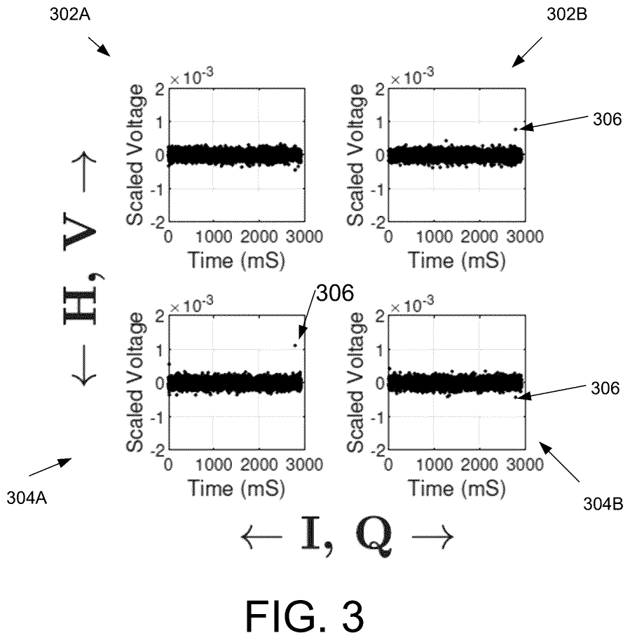

FIG. 3 depicts the filtered first polarization data 111A and filtered second polarization data 111B, according to examples. Each x-axis represents time and each y-axis represents scaled voltage. Plot 302A depicts a truncated version of the first filtered in-phase component I 110A, plot 302B depicts a truncated version of the first filtered quadrature component Q 110B, plot 304A depicts a truncated version of the second filtered in-phase component I 112A and plot 304B depicts a truncated version of the second filtered quadrature component Q 112B, according to examples. In plots 302A-304B, it may be seen that there is no bulge in the data, and the data appears to be statistically stationary, or the mean and variance of the data does not appear to change substantially over the time base of the data.

In examples, time series data may be further truncated to remove clutter. For radar applications in particular, clutter may include unwanted echoes from non-target objects such as terrain, buildings, weather, birds or sea waves that interfere with the detection of actual targets. Typically clutter is found in the areas closest to the instrument, below a minimal gate value. In examples, when radar are imaging closer to the ground, there may be more clutter than when the radar is imaging higher above the horizon.

In examples, the first polarization channel data 103A and the second polarization channel data 103B may be truncated below a minimal gate value to remove clutter. In examples, the minimal gate value for the example S-Pol radar may be gate value of 400, which corresponds a range of time series data adjacent to the value with an index of zero of the array. In FIG. 3, first polarization channel data 103A and second polarization channel data 103B have been truncated where the time step is below a minimal gate value 400.

In examples, outlier data 306 in first channel time series data 103A and second channel time series data 103B may be identified and removed to improve the polarization purity measurement. For example, three outlier data 306 are noted in FIG. 3. Outlier data is any data greater than a predetermined distance from a mean of the time series data. In examples, outlier data 306 may be caused by interference in the dual-polarized antenna.

To remove the outlier data 306 from first channel time series data 103A and second channel time series data 103B, each of the four time series components including respective I and Q data may be filtered. For example, the outlier data 306 may be removed from the first in-phase component I 104A, the first quadrature component Q 104B, the second in-phase component I 106A, and the second quadrature component Q 106B. Alternatively, depending on the sequencing of the filtering, the outlier data at N may be filtered from the first filtered in-phase component I 110A, the first filtered quadrature component Q 110B, the second filtered in-phase component 112A, and second filtered quadrature component Q 112B.

For example, outlier data 306 may be identified at time step N by determining that the value of any of the four time series data sets representing first polarization channel data 103A and second polarization channel data 103B at N includes a value that is more than a predetermined distance away from a first polarization data mean or a second polarization data mean. In examples, a polarization data mean may comprise a mean of the data in an individual I or Q time series. So, for example, it may be determined that the value of first in-phase component I 104A at N is more than a first in-phase component I mean value. And so forth for the remaining time series data that can represent first polarization channel data 103A, second polarization channel data 103B, filtered first polarization data 111A, or filtered second polarization data 111B. The data at N may then be filtered from all four time series data sets associated with the first and second channels. In examples, outlier data 306 at N may be removed or by setting the value at N to the first in-phase component mean value.

In examples, the predetermined distance over which outlier data 306 may be removed may be two sigma (i.e., 2 standard deviations), six sigma, ten sigma, or more away from the mean of the first in-phase component I 104A.

Method 100 may continue with step 114. In step 114, a polarity error 116 may be determined. In examples, the polarity error 116 may be represented by a tilt polarity mismatch and/or a ellipticity polarity mismatch. In examples, the filtered first polarization data 111A and filtered second polarization data 111B may be used to generate a mean cross-correlation coefficient value that is used in turn to determine the tilt and ellipticity polarity mismatches.

In examples, a measured cross-correlation coefficient Puy is determined based on the filtered first polarization data 111A and the filtered second polarization data 111B. How the tilt polarity mismatch and the ellipticity polarity mismatch are determined based on dual-polarized antenna measurements of noise with random polarity is described below.

As stated above, the performance of a dual-polarized antenna depends heavily on polarization purity between two orthogonal polarization states, or the ability to avoid cross-polarization leakage. A Jones vector may be used to represent the polarization state of an incident electric field, allowing analysis of deviations from ideal orthogonality. A polarization mismatch α, may represent the degree of non-orthogonality of the dual-polarized antenna. To quantify this polarization mismatch α, a mathematical framework may be utilized where the deviation from ideal orthogonality is modeled using a modified Jones vector. The polarization mismatch term α is complex and may be related to the measured cross-correlation coefficient ρ_{HV} to provide a practical way to estimate polarization leakage using first channel time series data 103A and second channel time series data 103B. A Pearson cross-correlation coefficient is used as a measure of similarity between the polarization channels, with the key insight being that in a perfectly random incident field (e.g., precipitation returns, thermal noise), measured cross-correlation coefficient ρ_{HV} should ideally be low, while a structured polarization state (e.g., 45° linear) may still show high correlation even with orthogonally aligned antennas. A relationship may therefore be established between polarization purity, cross-correlation, and system imperfections, providing a foundation for monitoring and correcting polarization errors in polarimetric radar systems.

In examples, the deviation of the measured cross-correlation coefficient per from zero for randomly polarized incident fields may be modeled using a multivariate circular Gaussian model, which assumes a uniform probability distribution of polarization states on the Poincaré sphere to allow for real-time monitoring of polarization purity in polarimetric phased array radar. In examples, the approach may be generalized to applications with unequal received signal variances, linking it to differential reflectivity Z_{DR} and enabling simultaneous estimation of polarization errors during live science or weather observations. The geometric framework of the Poincaré sphere may further allow for the polarization mismatch α to be expressed in terms of ellipticity ϵ and tilt τ of a polarization ellipse, values that are more intuitive for setting tolerances in radar measurements such as differential reflectivity Z_{DR}. The polarization mismatch α, may therefore be rewritten as a function of ellipticity ϵ and tilt τ:

$$ρ = {\vec{u}}_{∥}^{†} {\vec{u}}_{⊥} \approx ∓ cos ( 2 {∈}_{∥} ) {δ}_{τ} \pm i {δ}_{ϵ} , \qquad ( Equation 2 )$$

wherein ρ is a Pearson cross-correlation coefficient, \vec{u}_{⊥} and \vec{u}_{∥} are polarization states, δᵣ represents the tilt polarization mismatch, and δ_{ϵ} represents the ellipticity polarization mismatch. Equation 2 may allow the measured cross-correlation coefficient ρ_{HV} to be expressed directly in terms of ellipticity ϵ and tilt τ parameters, thereby making it easier to assess deviations from ideal polarization orthogonality.

To validate Equation 2 for polarimetric noise observations, the inventors used a joint circular Gaussian probability density function to model incident radiation, which is a standard for distributed targets and results in a uniform probability density function of polarization states on the Poincaré sphere. A Monte Carlo simulation was performed using MATLAB's built-in randn function with the 1i option to generate zero-mean, unit-variance circular normal (CN(0,1)) complex samples, ensuring that both real and imaginary components had equal variance. The polarization components E∥ and E⊥ were then computed using these samples and known Jones vectors to assess ellipticity polarization mismatch δϵ and tilt polarization mismatch δτ.

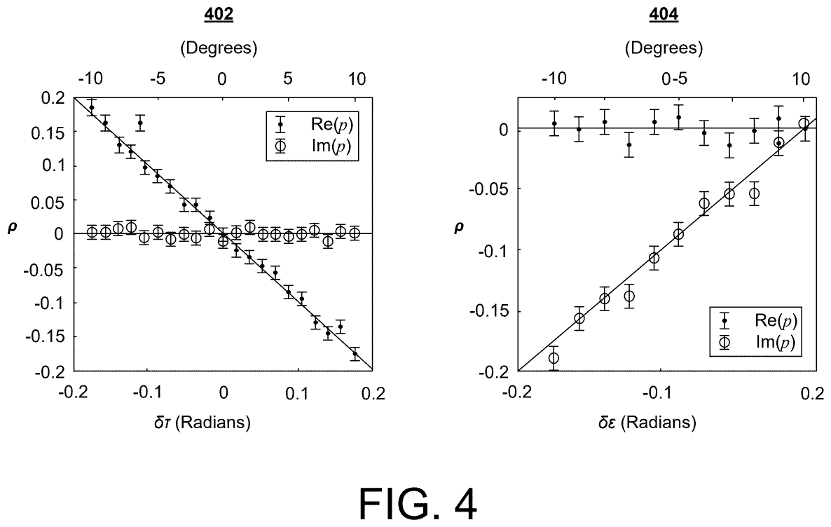

For each mismatch pair, 10⁴ samples of Jones vectors were generated, and a measured cross-correlation coefficient ρ_{HV} was computed for each ensemble of 20,000 values. The results are shown in FIG. 4. FIG. 4 depicts a first plot 402 of cross-correlation coefficient ρ vs tilt polarization mismatch δτ and a second plot 404 of cross-correlation coefficient ρ vs ellipticity polarization mismatch δϵ, according to examples.

The first plot 402 depicts how the complex cross-correlation coefficient ρ changes as the tilt angle t of one receiving antenna varies while the other remains fixed. The x-axis represents the tilt polarization mismatch &t when one receiver is held at −45°, and the other varies from +35° to +55° in 1° increments. The real part of p (depicted with a solid line) follows a linear dependence with slope −1 with no offset, as predicted by Equation 2, confirming the theoretical model.

The second plot 404 depicts the complex cross-correlation coefficient ρ dependence on ellipticity polarization mismatch δϵ when the right circular polarization antenna deviates from ϵ=+π/4 by a given δϵ. The x-axis represents ellipticity polarization mismatch δϵ in the right circular receiver, while the left circular receiver remains unchanged. Unlike in first plot 402, the real part of complex cross-correlation coefficient ρ remains constant and does not depend on ellipticity polarization mismatch δϵ. However, the imaginary portion of complex cross-correlation coefficient ρ exhibits a linear dependence on ellipticity polarization mismatch δϵ, confirming Equation 2. The error bars in first plot 402 are identical to those in second plot 404, representing the statistical uncertainty (1/√N) in the Monte Carlo samples.

In the example of a radar that has a horizontal and vertical polarization orientations, cos(2∈_{∥})=1, and Equation 2 reduces to:

$${δ}_{τ} + j {δ}_{ϵ} = Re ( {ρ}_{H V} ) + Im ( {ρ}_{H V} ) , \qquad ( Equation 3 )$$

where Re(ρ_{HV}) represents the real component of measured cross-correlation coefficient ρ_{HV}, and Im(ρ_{HV}) represents the complex component of measured cross-correlation coefficient ρ_{HV}. In examples, Equation 2 may be used to determine the tilt polarization mismatch δτ and ellipticity polarization mismatch δϵ based on measurements of randomly polarized noise.

The University Corporation for Atmospheric Research S-Pol radar data described above with regards to FIGS. 2 and 3 may be used to demonstrate the effectiveness of the polarization mismatch measurement approach.

The measured cross-correlation coefficient ρ_{HV} is a scalar complex number that may be determined using the standard Pearson correlation. In examples, the measured cross-correlation coefficient ρ_{HV} for each time step i may be determined as follows:

$${ρ}_{H V} = \frac{{\sum }_{i = 1}^{N} {V}_{H , i} {V}_{V , i}^{*}}{\sqrt{{\sum }_{i = 1}^{N} {V}_{H , i} {V}_{H , i}^{*} {\sum }_{i = 1}^{N} {V}_{V , i} {V}_{V , i}^{*}}} , \qquad ( Equation 4 )$$

wherein N is a time series length, V_{V,i}* is the first channel time series data 103B and V_{H,i} is the second channel time series data 103B. V_{V,i}* and V_{H,i} are complex voltage signals, as described in Equation 1. The measured cross-correlation coefficient ρ_{HV} may by represented by an array of complex scalar values.

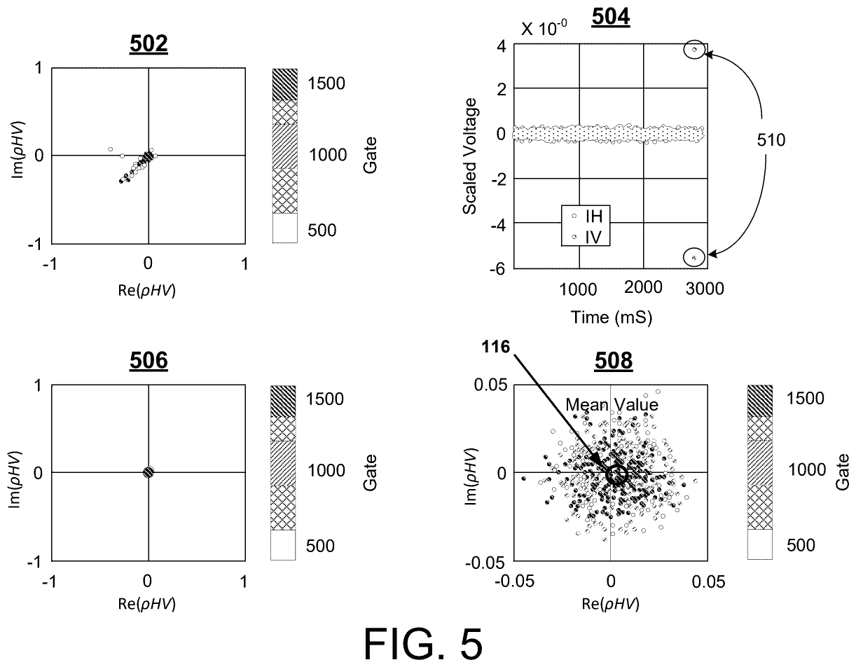

FIG. 5 depicts four plots including S-Pol radar data, according to examples. First plot 502, third plot 506, and fourth plot 508 each depict measured cross-correlation coefficient ρ_{HV}, with the x-axis representing the real component RE(ρ_{HV}) and the y-axis representing the imaginary component Im(ρ_{HV}). The second plot 504 depicts the time series data with the x-axis representing time and the y-axis representing scaled voltage. The plots illustrate an example computation of a mean cross-correlation coefficient value.

First plot 502 depicts measured cross-correlation coefficient ρ_{HV} values that appear to include wide a spread of values as far as |0.3| of the origin, which is relatively high.

Second plot 504 depicts time series data with outlier data 510. Using the techniques described with respect to the step 108 above, it is possible to remove the outlier data 510. Once removed, it may be seen from third plot 506 that the measured cross-correlation coefficient ρ_{HV} values align more closely with one another around the origin of the plot. Fourth plot 508 depicts a zoomed in view of the filtered measured cross-correlation coefficient ρ_{HV}, which is much more tightly concentrated from −0.05 to 0.05. In the fourth plot 508, the plotted measured cross-correlation coefficients ρ_{HV} appear to stack up closely together. Here the outlier data has been removed from the time series data before calculating the measured cross-correlation coefficient ρ_{HV}, and it can be seen that all the values are within |0.05| of the origin.

In examples, a mean cross-correlation coefficient may be determined based on the measured cross-correlation coefficients ρ_{HV}. In examples, measured cross-correlation coefficients ρ_{HV} may be the mean of the measured cross-correlation coefficients ρ_{HV}. For examples, in fourth plot 508, it may be seen that the measured cross-correlation coefficient ρ_{HV} is plotted by Re(ρ_{HV}) real and Im(ρ_{HV}) imaginary components, with the mean cross-correlation coefficient identified with a small circle.

Once the mean cross-correlation coefficient is determined, Equation 2 may be used to solve for tilt polarization mismatch δτ and ellipticity polarization mismatch δϵ.

In examples, method 100 further include step 120. In step 120, a mitigation action may be initiated for the dual-polarized antenna based on the polarization error (e.g., the tilt polarization mismatch δτ and/or ellipticity polarization mismatch δϵ). In examples, the mitigation action may be initiated upon determining that the tilt polarity mismatch is not within a tilt tolerance or the ellipticity polarity mismatch is not within an ellipticity tolerance.

In examples, the mitigation action may include sending an indication that at least one of the tilt polarity mismatch is not within the tilt tolerance or the ellipticity polarity mismatch is not within the ellipticity tolerance. In examples, a message may be displayed or sent to an operator. In examples, a report may be generated. In examples, a phase shifter within the dual-polarization antenna may be adjusted to reduce at least one of the tilt polarity mismatch or the ellipticity polarity mismatch. In examples, the replacement of a dual-polarized antenna element may be initiated. In examples, where the dual-polarized antenna element may be one of a plurality of dual-polarized antenna elements the mitigation action may include identifying the dual-polarized antenna out of the plurality of dual-polarized antennas as including the polarization error. In examples, other operational mitigation actions may include polarization filtering techniques and advanced calibration algorithms to maintain polarization purity and minimize leakage. On the hardware side, polarization mismatch may be addressed via antenna design optimization, the use of hybrid polarity networks, digital polarization control algorithms, and/or adaptive compensation techniques.

The technique described in this disclosure provide advantages over the prior art because they may be performed without a sphere calibration or ellipsometry. Instead, randomly polarized solar microwave radiation or other randomly polarized radiation may be used to calibrate the orthogonality of dual-channel receivers' polarization states in-situ. In other words, the proposed approach may be implemented with the dual-polarized antenna remaining in its normal operating environment during a brief interruption to regular transmit and receive modes to detect polarization errors in both transmit and receive modes. This significantly reduces the downtime for an instrument and allows for ongoing monitoring of polarization purity.

The technique proposed herein may be applied to any antenna system such as a dish or dual-polarized antenna with any polarization basis (linear, circular or elliptical). In addition, the proposed technique may be applied in commercial applications in 5G/6G wireless communications and biomedical devices. The technique may be further applied to military radars.

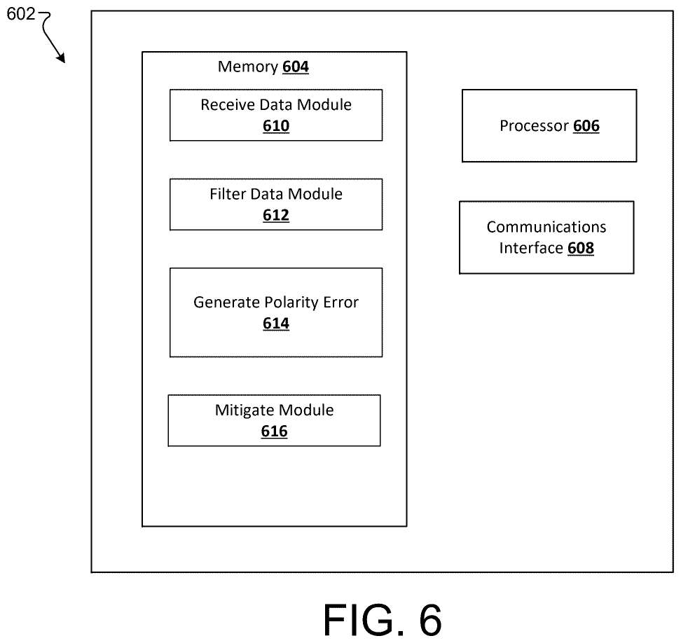

FIG. 6 depicts a computing device 602 that may be used to execute the methods described herein, according to examples. In examples, computing device 602 may be an embedded device co-located with a geophysical instrument, for example a radar or radiometer, or computing device 602 may be remotely located. In examples, computing device 602 may be used to process data from the geophysical instrument in real time or in post-processing.

Computing device 602 includes a memory 604, a processor 606, and a communications interface 608. In examples, memory 604 may include one or more memories. In examples, processor 606 may include one or more processors. Memory 604 may include one or more modules operable to execute the method 100. For example, memory 604 may include any combination of a receive data module 610, a filter data module 612, a generate cross-correlation coefficient module 614, or a mitigate module 616.

In examples, computing device 602 may receive raw data or measured data from a dual-polarized antenna. In examples, the computing device 602 may also communicate with a server over a network (not depicted).

In some aspects, the techniques described herein relate to a method, wherein determining the tilt polarity mismatch and the ellipticity polarity mismatch based on the filtered first polarization data and the filtered second polarization data further includes: determining a measured cross-correlation coefficient array based on the filtered first polarization data and the filtered second polarization data; and determining a mean cross-correlation coefficient based on the measured cross-correlation coefficient array, wherein the mean cross-correlation coefficient is used to determine the tilt polarity mismatch and the ellipticity polarity mismatch.

In some aspects, the techniques described herein relate to a method, wherein the measured cross-correlation coefficient array is generated based on, where N is a time series length, and is the filtered first polarization data and is the filtered second polarization data.

In some aspects, the techniques described herein relate to a method, wherein the predetermined distance is six sigma.

In some aspects, the techniques described herein relate to a method, wherein generating the filtered first polarization data further includes removing clutter from the first polarization data and generating the filtered second polarization data further includes removing clutter from the second polarization data.

In some aspects, the techniques described herein relate to a method, wherein generating the filtered first polarization data and generating the filtered second polarization data further includes removing a time range of data from the filtered first polarization data and the filtered second polarization data when any combination of the first polarization data or the second polarization data is not statistically stationary.

In some aspects, the techniques described herein relate to a method, further including: upon determining that the tilt polarity mismatch is not within a tilt tolerance or the ellipticity polarity mismatch is not within an ellipticity tolerance, sending an indication that at least one of the tilt polarity mismatch is not within the tilt tolerance or the ellipticity polarity mismatch is not within the ellipticity tolerance.

In some aspects, the techniques described herein relate to a method, further including: upon determining that the tilt polarity mismatch is not within a tilt tolerance or the ellipticity polarity mismatch is not within an ellipticity tolerance, adjusting a phase shifter to reduce at least one of the tilt polarity mismatch or the ellipticity polarity mismatch or initiating replacement of the dual-polarized antenna.

In some aspects, the techniques described herein relate to a method, further including: directing a receiver of the dual-polarized antenna towards the noise source.

In some aspects, the techniques described herein relate to a system, wherein determining the tilt polarity mismatch and the ellipticity polarity mismatch based on the filtered first polarization data and the filtered second polarization data further includes: determining a measured cross-correlation coefficient array based on the filtered first polarization data and the filtered second polarization data; and determining a mean cross-correlation coefficient based on the measured cross-correlation coefficient array, wherein the mean cross-correlation coefficient is used to determine the tilt polarity mismatch and the ellipticity polarity mismatch.

In some aspects, the techniques described herein relate to a system, wherein the measured cross-correlation coefficient array is generated based on, where N is a time series length, and is the filtered first polarization data and is the filtered second polarization data.

In some aspects, the techniques described herein relate to a system, wherein generating the filtered first polarization data and generating the filtered second polarization data further includes removing a time range of data from the filtered first polarization data and the filtered second polarization data when any combination of the first polarization data or the second polarization data is not statistically stationary.

In some aspects, the techniques described herein relate to a system, wherein the memory is further configured with code operable to: upon determining that the tilt polarity mismatch is not within a tilt tolerance or the ellipticity polarity mismatch is not within an ellipticity tolerance, send an indication that at least one of the tilt polarity mismatch is not within the tilt tolerance or the ellipticity polarity mismatch is not within the ellipticity tolerance.

In some aspects, the techniques described herein relate to a system, wherein the memory is further configured with code operable to: upon determining that the tilt polarity mismatch is not within a tilt tolerance or the ellipticity polarity mismatch is not within an ellipticity tolerance, adjust a phase shifter to reduce at least one of the tilt polarity mismatch or the ellipticity polarity mismatch or initiating replacement of the dual-polarized antenna.

In some aspects, the techniques described herein relate to a non-transitory computer-readable medium, wherein determining the tilt polarity mismatch and the ellipticity polarity mismatch based on the filtered first polarization data and the filtered second polarization data further includes: determining a measured cross-correlation coefficient array based on the filtered first polarization data and the filtered second polarization data; and determining a mean cross-correlation coefficient based on the measured cross-correlation coefficient array, wherein the mean cross-correlation coefficient is used to determine the tilt polarity mismatch and the ellipticity polarity mismatch.

In some aspects, the techniques described herein relate to a non-transitory computer-readable medium, wherein the measured cross-correlation coefficient array is generated based on, where N is a time series length, and is the filtered first polarization data and is the filtered second polarization data.

In some aspects, the techniques described herein relate to a non-transitory computer-readable medium, wherein generating the filtered first polarization data and generating the filtered second polarization data further includes removing a time range of data from the filtered first polarization data and the filtered second polarization data when any combination of the first polarization data or the second polarization data is not statistically stationary.

In some aspects, the techniques described herein relate to a non-transitory computer-readable medium, wherein the instructions, when executed by the processor, further cause the processor to: upon determining that the tilt polarity mismatch is not within a tilt tolerance or the ellipticity polarity mismatch is not within an ellipticity tolerance, send an indication that at least one of the tilt polarity mismatch is not within the tilt tolerance or the ellipticity polarity mismatch is not within the ellipticity tolerance.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor or some other programmable data processing apparatus.

Methods discussed above may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, have many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

The terminology used herein is for the purpose of describing particular implementations only and is not intended to be limiting of example implementations. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

In the above illustrative implementations, reference to acts and symbolic representations of operations that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), Graphics Processing Units (GPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

1. A method comprising:
receiving, from a dual-polarized antenna, first polarization data from a first channel and second polarization data from a second channel having a polarization orientation that is different from the first channel, the first polarization data and the second polarization data representing signal from a noise source including randomly polarized noise;
generating filtered first polarization data by filtering data from the first polarization data that is more than a predetermined distance from a first polarization data mean;
generating filtered second polarization data by filtering data from the second polarization data that is more than the predetermined distance from a second polarization data mean; and
determining a tilt polarity mismatch and an ellipticity polarity mismatch based on the filtered first polarization data and the filtered second polarization data; wherein at least one of the tilt polarity mismatch or the ellipticity polarity mismatch are used to determine a polarity error of the dual-polarized antenna.

2. The method of claim 1, wherein determining the tilt polarity mismatch and the ellipticity polarity mismatch based on the filtered first polarization data and the filtered second polarization data further comprises:
determining a measured cross-correlation coefficient array based on the filtered first polarization data and the filtered second polarization data; and
determining a mean cross-correlation coefficient based on the measured cross-correlation coefficient array, wherein the mean cross-correlation coefficient is used to determine the tilt polarity mismatch and the ellipticity polarity mismatch.

3. The method of claim 2, wherein the measured cross-correlation coefficient array is generated based on
$${ρ}_{H V} = \frac{{\sum }_{i = 1}^{N} {V}_{H , i} {V}_{V , i}^{*}}{\sqrt{{\sum }_{i = 1}^{N} {V}_{H , i} {V}_{H , i}^{*} {\sum }_{i = 1}^{N} {V}_{V , i} {V}_{V , i}^{*}}} ,$$
where N is a time series length, and V_{V,i}* is the filtered first polarization data and V_{H,i} is the filtered second polarization data.

4. The method of claim 1, wherein the predetermined distance is six sigma.

5. The method of claim 1, wherein generating the filtered first polarization data further includes removing clutter from the first polarization data and generating the filtered second polarization data further includes removing clutter from the second polarization data.

6. The method of claim 1, wherein generating the filtered first polarization data and generating the filtered second polarization data further includes removing a time range of data from the filtered first polarization data and the filtered second polarization data when any combination of the first polarization data or the second polarization data is not statistically stationary.

7. The method of claim 1, further comprising:
upon determining that the tilt polarity mismatch is not within a tilt tolerance or the ellipticity polarity mismatch is not within an ellipticity tolerance, sending an indication that at least one of the tilt polarity mismatch is not within the tilt tolerance or the ellipticity polarity mismatch is not within the ellipticity tolerance.

8. The method of claim 1, further comprising:
upon determining that the tilt polarity mismatch is not within a tilt tolerance or the ellipticity polarity mismatch is not within an ellipticity tolerance, adjusting a phase shifter to reduce at least one of the tilt polarity mismatch or the ellipticity polarity mismatch or initiating replacement of the dual-polarized antenna.

9. The method of claim 1, further comprising:
directing a receiver of the dual-polarized antenna towards the noise source.

10. A system comprising:
a processor; and
a memory configured with code operable to:
receive, from a dual-polarized antenna, first polarization data from a first channel and second polarization data from a second channel having a polarization orientation that is different from the first channel, the first polarization data and the second polarization data representing signal from a noise source including randomly polarized noise,
generate filtered first polarization data by filtering data from the first polarization data that is more than a predetermined distance from a first polarization data mean,
generate filtered second polarization data by filtering data from the second polarization data that is more than the predetermined distance from a second polarization data mean, and
determine a tilt polarity mismatch and an ellipticity polarity mismatch based on the filtered first polarization data and the filtered second polarization data; wherein at least one of the tilt polarity mismatch or the ellipticity polarity mismatch are used to determine a polarity error of the dual-polarized antenna.

11. The system of claim 10, wherein determining the tilt polarity mismatch and the ellipticity polarity mismatch based on the filtered first polarization data and the filtered second polarization data further comprises:
determining a measured cross-correlation coefficient array based on the filtered first polarization data and the filtered second polarization data; and
determining a mean cross-correlation coefficient based on the measured cross-correlation coefficient array, wherein the mean cross-correlation coefficient is used to determine the tilt polarity mismatch and the ellipticity polarity mismatch.

12. The system of claim 11, wherein the measured cross-correlation coefficient array is generated based on
$${ρ}_{H V} = \frac{{\sum }_{i = 1}^{N} {V}_{H , i} {V}_{V , i}^{*}}{\sqrt{{\sum }_{i = 1}^{N} {V}_{H , i} {V}_{H , i}^{*} {\sum }_{i = 1}^{N} {V}_{V , i} {V}_{V , i}^{*}}} ,$$
where N is a time series length, and V_{V,i}* is the filtered first polarization data and V_{H,i} is the filtered second polarization data.

13. The system of claim 10, wherein generating the filtered first polarization data and generating the filtered second polarization data further includes removing a time range of data from the filtered first polarization data and the filtered second polarization data when any combination of the first polarization data or the second polarization data is not statistically stationary.

14. The system of claim 10, wherein the memory is further configured with code operable to:
upon determining that the tilt polarity mismatch is not within a tilt tolerance or the ellipticity polarity mismatch is not within an ellipticity tolerance, send an indication that at least one of the tilt polarity mismatch is not within the tilt tolerance or the ellipticity polarity mismatch is not within the ellipticity tolerance.

15. The system of claim 10, wherein the memory is further configured with code operable to:
upon determining that the tilt polarity mismatch is not within a tilt tolerance or the ellipticity polarity mismatch is not within an ellipticity tolerance, adjust a phase shifter to reduce at least one of the tilt polarity mismatch or the ellipticity polarity mismatch or initiating replacement of the dual-polarized antenna.

16. A non-transitory computer-readable medium storing instructions that, when executed by a processor, cause the processor to:
receive, from a dual-polarized antenna, first polarization data from a first channel and second polarization data from a second channel having a polarization orientation that is different from the first channel, the first polarization data and the second polarization data representing signal from a noise source including randomly polarized noise;
generate filtered first polarization data by filtering data from the first polarization data that is more than a predetermined distance from a first polarization data mean;
generate filtered second polarization data by filtering data from the second polarization data that is more than the predetermined distance from a second polarization data mean; and
determine a tilt polarity mismatch and an ellipticity polarity mismatch based on the filtered first polarization data and the filtered second polarization data; wherein at least one of the tilt polarity mismatch or the ellipticity polarity mismatch are used to determine a polarity error of the dual-polarized antenna.

17. The non-transitory computer-readable medium of claim 16, wherein determining the tilt polarity mismatch and the ellipticity polarity mismatch based on the filtered first polarization data and the filtered second polarization data further comprises:
determining a measured cross-correlation coefficient array based on the filtered first polarization data and the filtered second polarization data; and
determining a mean cross-correlation coefficient based on the measured cross-correlation coefficient array, wherein the mean cross-correlation coefficient is used to determine the tilt polarity mismatch and the ellipticity polarity mismatch.

18. The non-transitory computer-readable medium of claim 17, wherein the measured cross-correlation coefficient array is generated based on
$${ρ}_{H V} = \frac{{\sum }_{i = 1}^{N} {V}_{H , i} {V}_{V , i}^{*}}{\sqrt{{\sum }_{i = 1}^{N} {V}_{H , i} {V}_{H , i}^{*} {\sum }_{i = 1}^{N} {V}_{V , i} {V}_{V , i}^{*}}} ,$$
where N is a time series length, and V_{V,i}* is the filtered first polarization data and V_{H,i} is the filtered second polarization data.

19. The non-transitory computer-readable medium of claim 16, wherein generating the filtered first polarization data and generating the filtered second polarization data further includes removing a time range of data from the filtered first polarization data and the filtered second polarization data when any combination of the first polarization data or the second polarization data is not statistically stationary.

20. The non-transitory computer-readable medium of claim 16, wherein the instructions, when executed by the processor, further cause the processor to:
upon determining that the tilt polarity mismatch is not within a tilt tolerance or the ellipticity polarity mismatch is not within an ellipticity tolerance, send an indication that at least one of the tilt polarity mismatch is not within the tilt tolerance or the ellipticity polarity mismatch is not within the ellipticity tolerance.
